(19) United States
(12) Patent Application Publication
(10) Pub. No.: US 2024/0378596 A1
(43) Pub. Date: Nov. 14, 2024

(54) System and Method for Validating an Interaction of a User Using Encrypted Data in a Distributed Network

(71) Applicant: Bank of America Corporation, Charlotte, NC (US)

(72) Inventors: Shailendra Singh, Thane West (IN); Saurabh Gupta, New Delhi (IN)

(21) Appl. No.: 18/315,567

(22) Filed: May 11, 2023

(51) Int. Cl. G06Q 20/38; G06Q 20/40

(52) U.S. Cl. CPC G06Q 20/38215; G06Q 20/4014; G06Q 20/4016

(57) ABSTRACT

An entity server receives a request from a user device to perform an interaction. The entity server is configured to receive an interaction data set associated with the interaction from a user device and in response to the request, the entity server retrieves encrypted data from a memory associated with a network node. The entity server compares the interaction data set to the encrypted data set and identifies an anomaly in the interaction data set based on the comparison. Once an anomaly is detected, the entity server denies the request from the user device to perform the interaction.

### TECHNICAL FIELD

The present disclosure relates generally to data security, and more specifically to a system and method for validating an interaction of a user using encrypted data in a distributed network.

### BACKGROUND

Skimming devices are attached over card readers at automated teller machine (ATM) terminals, self-service payment kiosks (e.g., gas pumps), or other point of sale (POS) equipment and are used to compromise account information of users. Compromised account information can lead to fraudulent interactions from bad actors.

### SUMMARY

The systems and methods described in the present disclosure provide practical applications and technical advantages that overcome the current technical problems described herein. Embodiments of the present disclosure are integrated into a practical application that allows the validation of a user device in a network in real time, which can be used to reduce or prevent anomalous interactions. In some embodiments, the provided systems and methods utilize network nodes within the network to maintain and store encrypted data associated with a user identifier. The encrypted data associated with the user identifier may include, but is not limited to, interaction pattern data of the user, time of interaction data, geolocation data of the user, and social media activity of the user. In response to a request from a user device to perform an interaction in the network, the provided systems and methods may retrieve the encrypted data from the network nodes and compare the encrypted data to an interaction data set associated with the interaction to identify an anomaly. In some embodiments, the anomaly is indicative of a fraudulent interaction. If the anomaly is detected, the provided systems and methods may deny the user device from performing the interaction. Conversely if no anomaly is detected, the provided systems and methods may allow the interaction to proceed. In some embodiments the encrypted data is stored using homomorphic encryption. Homomorphic encryption is an encryption method that allows computations to be performed on encrypted data without having to first decrypt the encrypted data using a decryption key. The results of the computations using homomorphic encryption also remain encrypted. The encrypted data can be decrypted by an entity server with a decryption key, but the network nodes will not have access to the decryption key.

The disclosed systems and methods provide several practical applications and technical advantages. First, the disclosed systems and methods provide real time validation of a user interaction to detect anomalous interactions. Real time validation of the user interaction provides the practical application and technical advantage of data security, which prevents unauthorized interactions. Preventing unauthorized interactions in real time avoids having to use computing and network resources in post to correct the unauthorized access. Second, the disclosed systems and methods provide reduced infrastructure cost and complexity by leveraging network node infrastructure that already exists in the network for distributed storage. The distributed storage allows for the practical application and technical advantage of allowing entities to avoid having to store the information within an entity server, and instead store the information in the network node infrastructure. Storing the information in the network node reduces infrastructure cost and complexity by allowing the entity server to avoid having to store the information. Third, the disclosed systems and methods provide encryption techniques, such as homomorphic encryption, that reduce computing power requirements by allowing computations to be performed on the encrypted data. The provided encryption techniques provide the practical application and technical advantage of reducing computing power requirements by avoiding the need to decrypt the data prior to performing computations. Fourth, the disclosed systems and methods provide encryption techniques, such as homomorphic encryption, that provide improved security of user information. The provided encryption techniques provide the practical application and technical advantage of improved security by storing the data in an encrypted form at the network nodes.

In one embodiment, the present disclosure provides a system for validating an interaction of a user on a user device in a network. The system comprises a memory operable to store an interaction data set associated with the interaction from the user device. The system comprises a processor operably coupled to the memory and configured to communicate with a first network node in the network, where the first network node receives a first data set associated with a first user identifier. The processor is configured to instruct the first network node to generate a first encrypted data set from the first data set and to instruct the first network node to store the first encrypted data set in a memory associated with the first network node. The processor is further configured to communicate with a second network node in the network, where the second network node receives a second data set associated with a second user identifier. The processor is configured to instruct the second network node to generate a second encrypted data set from the second data set and instruct the second network node to store the second encrypted data set in a memory associated with the second network node. In some embodiments, the processor is configured to receive a request from the user device to perform the interaction, wherein the processor is configured to receive the interaction data set associated with the interaction from the user device. In response to the request, the processor is configured to retrieve the first encrypted data set from the memory associated with the first network node and retrieve the second encrypted data set from the memory associated with the second network node. The processor is further configured to compare the interaction data set to the first encrypted data set and the second encrypted data set and identify an anomaly in the interaction data set based on the comparison. In some embodiments, the processor is configured to deny the request from the user device to perform the interaction based on detecting the anomaly.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system according to an embodiment of the present disclosure; and

FIG. 2 illustrates a flowchart of a method according to an embodiment of the present disclosure.

### DETAILED DESCRIPTION

As described above, the present disclosure provide systems and methods for validating an interaction of a user on a user device in a network. In some embodiments, the provided systems and methods utilize network nodes within the network to maintain and store encrypted data associated with a user identifier. In response to a request from a user device to perform an interaction in the network, the provided systems and methods may retrieve the encrypted data from the network nodes and compare the encrypted data to an interaction data set associated with the interaction to identify an anomaly. If the anomaly is detected, the provided systems and methods may deny the user device from performing the interaction. Conversely, if no anomaly is detected, the provided systems and methods may allow the interaction to proceed.

### System Overview:

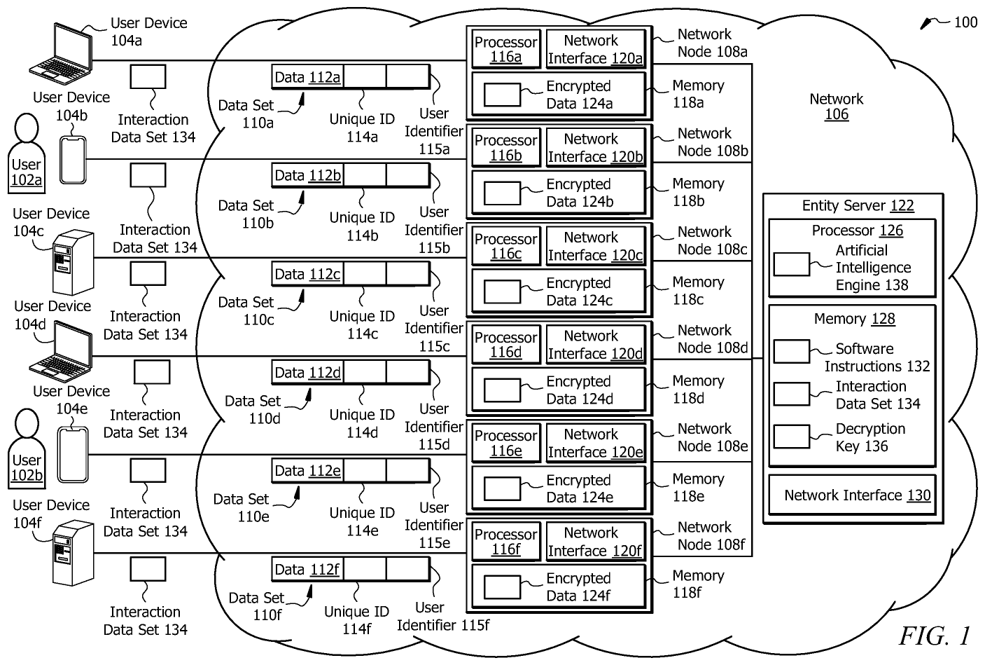

FIG. 1 illustrates an embodiment of a system 100 for validating an interaction of a user 102a-102b (e.g., a first user 102a and a second user 102b) on a user device 104a-104f (e.g., a first user device 104a, a second user device 104b, a third user device 104c, a fourth user device 104d, a fifth user device 104e, and a sixth user device 104f) in a network 106 that enables communications among components in the system 100. In some embodiments, the system 100 further comprises network nodes 108a-108f (e.g., a first network node 108a, a second network node 108b, a third network node 108c, a fourth network node 108d, a fifth network node 108e, and a sixth network node 108f). The network nodes 108a-108f are configured to receive data sets 110a-110f (e.g., a first data set 110a, a second data set 110b, a third data set 110c, a fourth data set 110d, a fifth data set 110e, and a sixth data set 110f) from a respective user device 104a-104f. The system 100 further comprises an entity server 122 in signal communication with the network nodes 108a-108f and the user devices 104a-104f. The entity server 122 comprises a processor 126 in signal communication with a memory 128 and a network interface 130.

In some embodiments, the system 100 validates an interaction of a user 102a-102b on a user device 104a-104f in the network 106. In general, the network nodes 108a-108f are configured to receive a data set 110a-110f associated with a user identifier 115a-115f from a respective user device 104a-104f. The entity server 122 is configured to instruct the network node 108a-108f to generate an encrypted data set 124a-124f from the data set 110a-110f associated with the user identifier 115a-115f, and store the encrypted data set 124a-124f in a memory 118a-118f of a respective network node 108a-108f. The encrypted data 120a-120f may include, but is not limited to, interaction pattern data of the user 102a-102b, time of interaction data, biometric information of the user 102a-102b, geolocation data of the user 102a-102b, and social media activity of the user 102a-102b. In some embodiments, the entity server 122 receives a request from the user device 104a-104f to perform an interaction. To validate the interaction, the entity server 122 may receive an interaction data set 134 associated with the interaction from the user device 104a-104f, and in response to the request, retrieve encrypted data 120a-120f from a respective network node 108a-108f. The interaction data set 134 may include, but is not limited to, a data value in the interaction, a timestamp for the interaction, item identification for the interaction, biometric data associated with the user 102a-102b during the interaction, and/or a geolocation of the interaction. The entity server 122 may then compare the interaction data set 134 to the encrypted data 120a-120f to identify an anomaly in the interaction data set 134 based on the comparison. For example, comparing the interaction data set 134 to the encrypted data 124a-124f includes comparing at least one of the interaction pattern data of the user 102a-102b, the time of interaction data, biometric information of the user 102a-102b, the geolocation data of the user 102a-102b, and the social media activity of the user 102a-102b provided by one or more network node 108a-108f to at least one of the data value in the interaction, the timestamp for the interaction, the item identification for the interaction, and the geolocation of the interaction to identify the presence or absence of an anomaly. An anomaly may be the identification of rare items, events or observations that deviate from and/or appear inconsistent with the remainder set of data. Any suitable anomaly detection technique may be performed to identify the anomaly including, but not limited to, statistical techniques (Z-score, Grubb's test), density-based techniques (k-nearest neighbor, local outlier factor), Bayesian networks, and clustering analysis-based outlier detection. If an anomaly is detected, the entity server 122 may deny the request from the user device 104a-104f to perform the interaction. Alternatively, if there is an absence of an anomaly, the entity server 122 may approve the interaction.

### System Components

### Network

Network 106 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 106 may be configured to support any suitable type of communication protocol as would be appreciated by one of ordinary skill in the art.

### User Device

User device 104a-104f is generally any device that is configured to acquire and process data 112a-112f, as well as interact with users 102a-102b. In some embodiments, the user device 104a-104f is in signal communication with the network nodes 108a-108f and the entity server 122. The user device 104a-104f is configured to send a request to the entity server 122 to perform an interaction (e.g., a transaction). The user device 104a-104f is also in signal communication with a respective network node 108a-108f and is configured to send data sets 114a-114f to the respective network nodes 108a-108f.

The data sets 110a-110f may each respectively comprise data 112a-112f associated with a user identifier 115a-115f. The user identifier 115a-115f may be a username for the user 102a-102b for a respective user device 104a-104f. For example, user 102a may have a user identifier 115a-115c for the respective user devices 104a-104c that generate data sets 110a-110c. In another example, the user 102b may have a user identifier 115d-115f for respective user devices 104d-104f that generates data sets 110d-110f.

In one particular example, user 102a may have a user identifier 115a for user device 104a. The user device 104a may filter the data 112a associated with the user identifier 115a from other data processed by the user device 104a. For example, the user device 104a may filter the data 112a associated with the user identifier 115a from the other data by attaching a unique identifier (“ID”) 114a to the data 112a and removing the other data that does not have the unique ID 114a. The user devices 104b-104f may also filter the respective data 112b-112f associated with the user identifier 115b-115c as described for user device 104a.

Examples of suitable user devices 104a-104f include, but are not limited to, a computer (e.g., desktop computer or laptop computer), an electronic tablet device, a smartphone (e.g., cell phone or a mobile phone), a smartwatch, a car's computing system, an Automated Teller Machine (ATM), a Point of Sale (POS) system, or may other portable consumer electronics device. The user devices 104a-104f are configured to acquire data 116a-116f that is associated with a user identifier 115a-115f. Exemplary data 116a-116f that is associated with a user identifier 115a-115f includes, but is not limited to, interaction pattern data (e.g., prior spending patterns of the user) of the user 102a-102b, time of interaction data (e.g., time of purchase data), biometric information (e.g., image, fingerprint, etc.) of the user 102a-102b, geolocation data of the user device 104a-104f, and social media activity of the user 102a-102b. The geolocation data may include current location data or a historic log of location data over a duration (e.g., past 24 hours, past month, past year). In one non-limiting example, the user device 104a-104f can acquire current interaction data (e.g., transaction data) or interaction pattern data of the user 102a-102b over a duration (e.g., past 24 hours, past month, past year). In one non-limiting example, the user device 104a-104f may include a camera or fingerprint scanner that can capture biometric information (e.g., an image or fingerprint) of the user 102a-102b during the current interaction or biometric information of the user 102a-102b associated with past interactions. In one non-limiting example, the user device 104a-104f may acquire social media activity of the user 102a-102b (e.g., current login attempt or historic login data).

In some embodiments, the user device 104a-104f is configured to acquire an interaction data set 134 associated with the interaction, and send the interaction data set 134 to the entity server 122. In some embodiments, the interaction data set 134 includes, but is not limited to, a spending amount in the interaction, a time of purchase for the interaction, item of purchase for the interaction, biometric data associated with the user 102a-102b during the interaction, and/or a geolocation of the interaction. In one non-limiting example, user device 104a-104f may include a camera or fingerprint scanner that can capture biometric information (e.g., an image or fingerprint) of the user 102a-102b during the interaction.

### Network Nodes

In some embodiments, the network nodes 108a-108f comprise a computing device, a virtual machine, a server, a work station, or the like. The network nodes 108a-108f comprise a processor 116a-116f operably coupled to a memory 118a-118f and a network interface 120a-120f. The network interface 120a-120f is configured to enable wired and/or wireless communications between the user device 104a-104f, the processor 116a-116f, and the memory 118a-118f. For example, the processor 116a-116f may receive the data set 110a-110f from the user device 104a-104f and store the data set 110a-110f in the form of encrypted data 124a-124f in the memory 118a-118f.

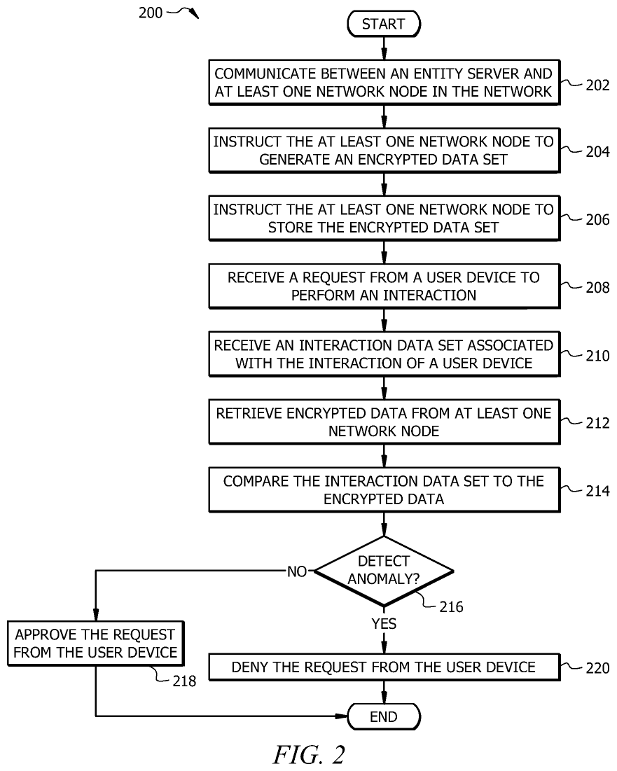

In a particular example, the processor 116a may comprise one or more processors. The processor 116a is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 116a may be a programmable logic device, a microcontroller, a microprocessor, or any suitable number and combination of the preceding. The processor 116a is configured to process data and may be implemented in hardware or software. For example, the processor 116a may be 8-bit, 16-bit, 32-bit, 64-bit, or of any other suitable architecture. The processor 116a may include an arithmetic logic unit (ALU) for performing arithmetic and logic operations. The processor 116a may register the supply operands to the ALU and store the results of ALU operations. The processor 116a may further include a control unit that fetches instructions from memory and executes them by directing the coordinated operations of the ALU, registers, and other components. The processor 116a is configured to implement various software instructions. For example, the processor 116a is configured to execute instructions (e.g., instructions received from entity server 122) to perform the operations of the network node 108a described herein. In this way, processor 116a may be a special-purpose computer designed to implement the functions disclosed herein. In an embodiment, the processor 116a is implemented using logic units, FPGAs, ASICs, DSPs, or any other suitable hardware. The processor 116a is configured to operate as described in FIGS. 1-2. For example, the processor 116a may be configured to perform one or more operations of the operational flow 200 as described in FIG. 2. In some embodiments, processors 116b-116f are configured to execute instructions to perform the operations of the respective network node 108b-108f in the same or similar way described for processor 116a.

In a particular example, the memory 118a may be volatile or non-volatile and may comprise read-only memory (ROM), random-access memory (RAM), ternary content-addressable memory (TCAM), dynamic random-access memory (DRAM), and static random-access memory (SRAM). The memory 118a may include one or more of a local database, cloud database, network-attached storage (NAS), etc. The memory 118a comprises one or more disks, tape drives, or solid-state drives, and may be used as an over-flow data storage device, to store programs when such programs are selected for execution, and to store instructions and data that are read during program execution. The memory 118a may store any of the information described in FIGS. 1-2 along with any other data, instructions, logic, rules, or code operable to implement the function(s) described herein when executed by processor 116a. For example, the memory 118a may store software instructions and encrypted data 124a. The software instructions may comprise any suitable set of instructions, logic, rules, or code operable to execute the processor 116a and perform the functions described herein, such as some or all of those described in FIGS. 1-2. In some embodiments, the memories 118b-118f are configured to perform the same functions for the respective processor 116b-116f, as described for memory 118a.

Network interface 120a is configured to enable wired and/or wireless communications. The network interface 120a may be configured to communicate data between the network node 108a and other components in the system 100 (e.g., the user device 104a and the entity server 122). For example, the network interface 120a may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 116a may be configured to send and receive data using the network interface 120a. The network interface 120a may be configured to use any suitable type of communication protocol. Network interfaces 120b-120f may operate to communicate data with network nodes 108b-108f in the same way as described for network node 120a.

### Entity Server

The system 100 further comprises an entity server 122 in signal communication with the network nodes 108a-108f and the user devices 104a-104f. The entity server 122 comprises a processor 126 in signal communication with a memory 128 and a network interface 134. The network interface 130 is configured to enable wired and/or wireless communications between the processor 126, the memory 128, the network node 108a-108f, and the user device 104a-104f. For example, the processor 126 may receive an interaction data set 134 that is associated with an interaction performed by the user device 104a-104f. The processor 126 may also receive encrypted data 124a-124f from the network nodes 108a-108f.

The processor 126 may comprise one or more processors. The processor 126 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 126 may be a programmable logic device, a microcontroller, a microprocessor, or any suitable number and combination of the preceding. The processor 126 is configured to process data and may be implemented in hardware or software. For example, the processor 126 may be 8-bit, 16-bit, 32-bit, 64-bit, or of any other suitable architecture. The processor 126 may include an arithmetic logic unit (ALU) for performing arithmetic and logic operations. The processor 126 may register the supply operands to the ALU and store the results of ALU operations. The processor 126 may further include a control unit that fetches instructions from memory and executes them by directing the coordinated operations of the ALU, registers, and other components. The processor 126 is configured to implement various software instructions 130 from the memory 128. For example, the processor 126 is configured to execute software instructions 130 to perform the operations of the entity server 122 described herein. In this way, processor 116a-116f may be a special-purpose computer designed to implement the functions disclosed herein. In an embodiment, the processor 126 is implemented using logic units, FPGAs, ASICs, DSPs, or any other suitable hardware. The processor 126 is configured to operate as described in FIGS. 1-2. For example, the processor 126 may be configured to perform one or more operations of the operational flow 200 as described in FIG. 2.

In some embodiments, the processor 126 comprises an artificial intelligence (AI) engine 138. The AI engine 138 may be implemented using software instructions 132 executed by the processor 120. The AI engine 138 may compare the interaction data set 134 to the encrypted data 124a-124f to identify an anomaly. The AI engine 138 may be implemented by a machine learning neural network. In some embodiments, the AI engine 138 is trained based on feature variables that include previously acquired encrypted data 124a-124f that is stored in the memory 118a-118f of the network node 108a-108f.

The memory 128 may be volatile or non-volatile and may comprise read-only memory (ROM), random-access memory (RAM), ternary content-addressable memory (TCAM), dynamic random-access memory (DRAM), and static random-access memory (SRAM). The memory 128 may include one or more of a local database, cloud database, network-attached storage (NAS), etc. The memory 128 comprises one or more disks, tape drives, or solid-state drives, and may be used as an over-flow data storage device, to store programs when such programs are selected for execution, and to store instructions and data that are read during program execution. The memory 128 may store any of the information described in FIGS. 1-2 along with any other data, instructions, logic, rules, or code operable to implement the function(s) described herein when executed by processor 126. For example, the memory 128 may store software instructions 132, an interaction data set 134 received from the user device 104a-104f, and a decryption key 136 that can be retrieved by the processor 126 to decrypt encrypted data 124a-124f. The software instructions 132 may comprise any suitable set of instructions, logic, rules, or code operable to execute the processor 126 and perform the functions described herein, such as some or all of those described in FIGS. 1-2.

Network interface 130 is configured to enable wired and/or wireless communications. The network interface 130 may be configured to communicate data between the entity server 122 and other components in the system 100 (e.g., the user device 104a-104f and the network node 108a-108f). For example, the network interface 130 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 126 may be configured to send and receive data using the network interface 130. The network interface 130 may be configured to use any suitable type of communication protocol.

### System Operation

FIG. 2 illustrates an operational flow 200 of the system 100 of FIG. 1 for validating an interaction of a user 102a-102b on a user device 104a-104f in a network 106 according to one or more embodiments described herein. The operational flow 200 can be logically described in two parts. The first part includes operations 202-206, which are generally directed to an entity server 122 instructing network nodes 108a-108f generate encrypted data set 124a-124f and store the encrypted data set 124a-124f at a respective network node 108a-108f. The second part includes operations 210-220, which are generally directed to receiving a request from a user device 104a-104f to perform an interaction having an interaction data set 134, and comparing the interaction data set 134 to an encrypted data set 124a-124f at a respective network node 108a-108f to identify an anomaly. In operation, the operational flow 200 may begin at operation 202 when the entity server 122 communicates with one or more of the network nodes 108a-108f in the network 106. For example, the entity server 122 may communicate with one or more network node 108a-108f to receive a data set 110a-110f associated with the user identifier 115a-115f. In some embodiments, the entity server 122 select the network nodes 108a-108f within the network 106. For example, the entity server 122 may communicate with a single network node (e.g., a first network node 108a) in the network 106, or alternatively with multiple network nodes (e.g., at least a first network node 108a and a second network node 108b) in the network 106 to receive a data set 110a-110f associated with the user identifier 115a-115f.

At operation 204, the entity server instructs the at least one network node to generate encrypted data 124a-124f from the data set 110a-110f associated with the user identifier 115a-115f. In some embodiments, the entity server 122 instructs the one or more network nodes 108a-108f to generate the encrypted data 124a-124f using homomorphic encryption. Homomorphic encryption is an encryption method that allows computations to be performed on the encrypted data 124a-124f without having to first decrypt the encrypted data 124a-124f using a decryption key 136. The results of the computations using homomorphic encryption also remain encrypted. The encrypted data can be decrypted by the entity server 122 with the decryption key 136. In other words, once the data set 110a-110f is transformed into encrypted data 124a-124f, the network node 108a-108f will not be able to decipher the encrypted data 124a-124f. Homomorphic encryption offers various advantages. For example, homomorphic encryption reduces computing power requirements by allowing computations to be performed on the encrypted data, thereby avoiding the need to decrypt the data prior to performing computations. Additionally, homomorphic encryption provides improved security of user information by storing the data in an encrypted form at the network nodes 108a-108f.

At operation 206, the entity server 122 instructs the one or more network node 108a-108f to store the encrypted data 124a-124f in a memory 118a-118f of the respective network node 108a-108f. As discussed above, the encrypted data 124a-124f stored at the one or more network node 108a-108f will comprise data 110a-110f associated with a user identifier 115a-115f. The user identifier 115a-115f may include at least one of: interaction pattern data of the user 102a-102b, time of interaction data, geolocation data of the user 102a, biometric information associated with the user 102a-102b, and social media activity of the user 102a-102b. Storing the encrypted data 124a-124f at the network nodes 108a-108f offers various advantages. For example, storing the encrypted data 124a-124f at the network nodes 108a-108f reduces infrastructure cost and complexity by leveraging network node 108a-108f infrastructure that already exists in the network 106 for distributed storage, which allows entities to avoid having to store the information within a memory 128 of the entity server 122. In some embodiments, the encrypted data 124a-124f stored in each respective network node 108a-108f may be associated with a user device type (e.g., a single user device type). For example the encrypted data 124a may be associated with the data set 110a provided by user device 104a, and the encrypted data 124b may be associated with the data set 110b provided by user device 104b, where the user device 104a is different from the user device 104b. In some embodiments, each network node 108a-108f includes encrypted data 124a-124f that is associated with a unique user device type (e.g., a laptop, smartphone, ATM, POS system, etc.)

At operation 208, the entity server 122 receives a request from one or more user device 104a-104f to perform an interaction, and the entity server 122 may validate the interaction in which case the operational flow 200 proceeds to operation 210 . . . . In some embodiments, operations 202-206 may continue to operate in the background in conjunction or simultaneously with operation 208, where the entity server 122 receives the interaction request.

At operation 210, the one or more user device 104a-104f sends an interaction data set associated with the interaction to the entity server 122. In some embodiments, the interaction is a transaction being performed by the user 102a-102b, and the entity server 122 may be a bank server that is configured to approve or deny the interaction request. In some embodiments, the interaction data set 134 includes at least one of a spending amount in the interaction, a time of purchase for the interaction, item of purchase for the interaction, biometric data associated with the user 102a-102b during the interaction, and a geolocation of the interaction.

At operation 212, the entity server 122 retrieves one or more encrypted data sets 124a-124f from a respective network node 108a-108f. In one particular example, user 102a may attempt to perform an interaction with user device 102a. The user device 102a may send the request from the user 102a to the entity server 122 with the interaction data set 134 associated with the interaction and encrypted data 124 from network node 108a. In some embodiments, the entity server 122 receives a single request, e.g., from user device 102a as described in the above example. In some embodiments, the entity server 122 receives a plurality of requests from the user 102a, e.g., from one or more user devices 104a-104c, or from multiple users 102b, e.g., from one or more user devices 104d-104f. For example, comparing the interaction data set 134 to the encrypted data 124a-124f includes comparing at least one of the interaction pattern data of the user 102a-102b, the time of interaction data, biometric information of the user 102a-102b, the geolocation data of the user 102a-102b, and the social media activity of the user 102a-102b provided by one or more network node 108a-108f to at least one of the spending amount in the interaction, the time of purchase for the interaction, the item of purchase for the interaction, and the geolocation of the interaction to identify the presence or absence of an anomaly. An anomaly may be the identification of rare items, events or observations that deviate from and/or appear inconsistent with the remainder set of data. Any suitable anomaly detection technique may be performed to identify the anomaly including, but not limited to, statistical techniques (Z-score, Grubb's test), density-based techniques (k-nearest neighbor, local outlier factor), Bayesian networks, and clustering analysis-based outlier detection. At step 214 the entity server 122 compares at least a portion of the interaction data set 134 to the one or more encrypted data sets 124a-124f, and at decision block 216, the entity server 122 identifies the presence of an anomaly based on the comparison, or identifies the absence of an anomaly based on the comparison.

If no anomaly is detected (e.g., the absence of an anomaly), then the operational flow 200 proceeds to operation 218, where the entity server 122 approves the request from the user device 104a-104b to perform the interaction. Conversely, if an anomaly is detected, the operational flow 200 proceeds to operation 220, where the entity server 122 denies the request from the user device 104a-104b to perform the interaction.

In some embodiments, operation 214 of comparing the interaction data set 134 to the encrypted data 124a-124f includes comparing at least one of the spending pattern data of the user 102a-102b, the time of purchase data, the geolocation data of the user 102a-102b, and the social media activity of the user 102a-102b provided by one or more network node 108a-108f to at least one of the spending amount in the interaction, the time of purchase for the interaction, the item of purchase for the interaction, and the geolocation of the interaction to identify the presence or absence of an anomaly.

As one non-limiting example, a user 102a who lives in Dallas, Texas may interact with a first user device 104a that is a laptop which records the geolocation data of the user 102a, a second user device 104b that is a smartphone which records social media activity of the user 102a, and a third user device 104c that is an ATM which records spending pattern data (e.g., withdrawals) of the user 102a. The first user device 104a sends the geolocation data to a first network node 108a, which is instructed by the entity server 122 to store the geolocation data as encrypted data 124a for a duration, the second user device 104b sends the social media activity to a second network node 108b, which is instructed by the entity server 122 to store the social media activity as encrypted data 124b for a duration, and the third user device 104c sends the spending pattern data of the user 102a to a third network node 108c, which is instructed by the entity server 122 to store the spending pattern data as encrypted data 124c for a duration.

In this example, the user 102a attempts to perform an interaction using user device 104f, which is an ATM located in Dallas, Texas. The interaction may have an interaction data set 134 that includes a spending amount in the interaction (e.g., a withdrawal from user device 104f, which is an ATM in Dallas, Texas). The entity server 122 may receive the request from user device 104f to perform the interaction, and in response to the request, the entity server 122 may retrieve the first encrypted data 124a, the second encrypted data 124b, the third encrypted data 124c and compare the interaction data set to the respective encrypted data 124a-124c to identify an anomaly. The entity server 122 may determine based on the comparison that the geolocation data of the user 102a as provided by the first network node 108a indicates that the user 102a was last in Dallas, Texas, the social media activity of the user 102a as provided by the second network node 108b indicates that the user 102 was last in Dallas, Texas, and the spending pattern data as provided by the third network node 108c indicates that the user 102 was last in Dallas, Texas. Since the user 102a is attempting to perform an interaction in Dallas, Texas, the entity server 122 may determine that no anomaly exists, and may approve the request of the user device 104f to perform the interaction.

Conversely, in a second non-limiting example, the user 102a attempts to perform an interaction using user device 104f, which a POS system located in Tampa, Florida. The interaction may have an interaction data set 134 that includes an item of purchase for the interaction, which is a boat. The entity server 122 may retrieve the request from user device 104f to perform the interaction, and in response to the request, the entity server 122 may retrieve the first encrypted data 124a, the second encrypted data 124b, and the third encrypted data 124c and compare the interaction data set to the respective encrypted data 124a-124c to identify an anomaly. The entity server 122 may determine based on the comparison that the geolocation data of the user 102a as provided by the first network node 108a indicates that the user 102a was last in Dallas, Texas, the social media activity of the user 102a as provided by the second network node 108b indicates that the user 102 was last in Dallas, Texas, and the spending pattern data as provided by the third network node 108c indicates that the user 102 was last in Dallas, Texas. Since the user 102a is attempting to perform an interaction in Tampa, Florida and the item of purchase does not match the spending pattern data of the user 102a, the entity server 122 may determine that an anomaly exists, and may deny the request of the user device 104f to perform the interaction.

In some embodiments, the AI engine 138 performs the comparison of the interaction data 134 to the encrypted data 124a-124f, and the AI engine 138 is trained based on feature variables from the encrypted data 124a-124f.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A system for validating an interaction of a user in a network, the system comprising:
a memory operable to store an interaction data set associated with the interaction from a user device associated with the user;
a processor operably coupled to the memory and configured to:
communicate with a first network node in the network, wherein the first network node receives a first data set associated with a first user identifier;
instruct the first network node to generate a first encrypted data set from the first data set;
instruct the first network node to store the first encrypted data set in a memory associated with the first network node;
communicate with a second network node in the network, wherein the second network node receives a second data set associated with a second user identifier;
instruct the second network node to generate a second encrypted data set from the second data set;
instruct the second network node to store the second encrypted data set in a memory associated with the second network node;
receive a request from the user device to perform the interaction, wherein the processor is configured to receive the interaction data set associated with the interaction from the user device, and in response to the request:
retrieve the first encrypted data set from the memory associated with the first network node;
retrieve the second encrypted data set from the memory associated with the second network node;
compare the interaction data set to the first encrypted data set and the second encrypted data set;
identify an anomaly in the interaction data set based on the comparison; and
deny the request from the user device to perform the interaction.

2. The system of claim 1, wherein the processor is further configured to instruct the first network node to generate the first encrypted data set and instruct the second network node to generate the second encrypted data set using homomorphic encryption.

3. The system of claim 1, wherein the first encrypted data set of the first network node and the second encrypted data set of the second network node each comprise at least one of interaction pattern data of the user, time of interaction data, geolocation data of the user, an image associated with the user, and social media activity of the user.

4. The system of claim 3, wherein the interaction data set comprises at least one of a spending amount in the interaction, a time of purchase for the interaction, item of purchase for the interaction, and a geolocation of the interaction,
wherein comparing the interaction data set to the first encrypted data set and the second encrypted data set comprises comparing at least one of the interaction pattern data of the user, the time of interaction data of the user, the geolocation data of the user, the image associated with the user, and the social media activity of the user to the spending pattern data of the user, the time of purchase data, the geolocation data of the user, and the social media activity of the user provided by the first network node and the second network node to at least one of the spending amount in the interaction, the time of purchase for the interaction, the item of purchase for the interaction, and the geolocation of the interaction to identify the anomaly.

5. The system of claim 1, wherein the processor comprises an artificial intelligence engine that compares the interaction data set to the first encrypted data set and the second encrypted data set to identify the anomaly, wherein the artificial intelligence engine is trained based on feature variables from the first encrypted data set and the second encrypted data set.

6. The system of claim 1, wherein the memory is operable to store a second interaction data set associated with a second interaction from a second user device;
wherein the processor is further configured to:
communicate with a third network node in the network, wherein the third network node receives a third data set associated with a third user identifier;
instruct the third network node to generate a third encrypted data set from the third data set;
instruct third network node to store the third encrypted data set in a memory associated with the third network node;
receive a request from the second user device to perform the second interaction, wherein the processor is configured to receive the second interaction data set associated with the second interaction from the second user device, and in response to the request:
retrieve the third encrypted data set from the memory associated with the third network node;
compare the second interaction data set to the third encrypted data set;
identify an anomaly in the second interaction data set based on the comparison; and
deny the request from the user device to perform the second interaction.

7. The system of claim 1, wherein the first encrypted data in the first network node is associated with a first user device type and the second encrypted data in the second network node is associated with a second user device type, wherein the first user device type and the second user device type are different.

8. A method for validating an interaction of a user in a network, the method comprising:
communicating between an entity server and a first network node in the network, wherein the first network node receives a first data set associated with a first user identifier;
instructing, using the entity server, the first network node to generate a first encrypted data set from the first data set;
instructing, using the entity server, the first network node to store the first encrypted data set in a memory associated with the first network node;
communicating between the entity server and a second network node in the network, wherein the second network node receives a second data set associated with a second user identifier;
instructing, using the entity server, the second network node to generate the second encrypted data set from the second data set;
instructing, using the entity server, the second network node to store the second encrypted data set in a memory associated with the second network node;
sending a request to perform the interaction from a user device associated with the user to the entity server, wherein the entity server receives an interaction data set associated with the interaction from the user device, and in response to the request, the method comprises:
retrieving, using the entity server, the first encrypted data set from the memory associated with the first network node;
retrieving, using the entity server, the second encrypted data set from the memory associated with the second network node;
comparing, using entity server, the interaction data set to the first encrypted data set and the second encrypted data set;
identify an anomaly in the interaction data set based on the comparison; and
deny the request from the user device to perform the interaction.

9. The method of claim 8, wherein the method further includes comparing, using the entity server, the interaction data set to the first encrypted data set and the second encrypted data set using homomorphic encryption.

10. The method of claim 8, wherein the first encrypted data set of the first network node and the second encrypted data set of the second network node each comprise at least one of interaction pattern data of the user, time of interaction data, geolocation data of the user, an image associated with the user, and social media activity of the user.

11. The method of claim 10, wherein the interaction data set comprises at least one of a spending amount in the interaction, a time of purchase for the interaction, item of purchase for the interaction, and a geolocation of the interaction,
wherein comparing the interaction data set to the first encrypted data set and the second encrypted data set comprises comparing at least one of the interaction pattern data of the user, the time of interaction data of the user, the geolocation data of the user, the image associated with the user, and the social media activity of the user to the spending pattern data of the user, the time of purchase data, the geolocation data of the user, and the social media activity of the user provided by the first network node and the second network node to at least one of the spending amount in the interaction, the time of purchase for the interaction, the item of purchase for the interaction, and the geolocation of the interaction to identify the anomaly.

12. The method of claim 8 further comprising:
performing the comparison between the interaction data set to the first encrypted data set and the second encrypted data set an artificial intelligence engine to identify the anomaly, wherein the artificial intelligence engine is trained based on feature variables from the first encrypted data set and the second encrypted data set.

13. The method of claim 8 further comprising:
communicating between an entity server and a third network node in the network, wherein the third network node receives a third data set associated with a third user identifier;
instructing, using the entity server, the third network node to generate a third encrypted data set from the third data set;
instructing, using the entity server, the third network node to store the third encrypted data set in a memory associated with the third network node;
sending a request to perform the second interaction using the second user device to the entity server, wherein the entity server receives the second interaction data set associated with the second interaction from the second user device, and in response to the request, the method comprises:
retrieving, using the entity server, the third encrypted data set from the memory associated with the third network node;
comparing, using the entity server, the second interaction data set to the third encrypted data set;
identifying, using the entity server, an anomaly in the second interaction data set based on the comparison; and
denying, using the entity server, the request from the user device to perform the second interaction.

14. The method of claim 8, wherein the first encrypted data in the first network node is associated with a first user device type and the second encrypted data in the second network node is associated with a second user device type, wherein the first user device type and the second user device type are different.

15. A system for validating an interaction of a user in a network, the system comprising:
a first network node in the network, the first network node comprising a first processor configured to receive a first data set associated with a first user identifier, the first network node further comprising a memory associated with the first network node, the memory configured to store a first encrypted data set;
a second network node in the network, the first network node comprising a second processor configured to receive a second data set associated with a second user identifier, the second network node comprising a memory associated with the second network node, the memory configured to store a second encrypted data set;
an entity server comprising a memory operable to store an interaction data set associated with the interaction with a user device associated with the user, the entity server comprising a third processor operably coupled to the memory and configured to:
communicate with a first network node in the network;
instruct the first network node to generate the first encrypted data set from the first data set;
instruct the first network node to store the first encrypted data set in the memory associated with the first network node;
communicate with the second network node in the network;
instruct the second network node to generate the second encrypted data set from the second data set;
instruct the second network node to store the second encrypted data set in the memory associated with the second network node;
receive a request from the user device to perform the interaction, wherein the processor is configured to receive the interaction data set associated with the interaction from the user device, and in response to the request:
retrieve the first encrypted data set from the memory associated with the first network node;
retrieve the second encrypted data set from the memory associated with the second network node;
compare the interaction data set to the first encrypted data set and the second encrypted data set;
identify an anomaly in the interaction data set based on the comparison; and
deny the request from the user device to perform the interaction.

16. The system of claim 15, wherein the processor is configured to compare the interaction data set to the first encrypted data set and the second encrypted data set using homomorphic encryption.

17. The system of claim 15, wherein the first encrypted data set of the first network node and the second encrypted data set of the second network node each comprise at least one of interaction pattern data of the user, time of interaction data, geolocation data of the user, an image associated with the user, and social media activity of the user.

18. The system of claim 17, wherein the interaction data set comprises at least one of a spending amount in the interaction, a time of purchase for the interaction, item of purchase for the interaction, and a geolocation of the interaction,
wherein comparing the interaction data set to the first encrypted data set and the second encrypted data set comprises comparing at least one of the interaction pattern data of the user, the time of interaction data of the user, the geolocation data of the user, the image associated with the user, and the social media activity of the user to the spending pattern data of the user, the time of purchase data, the geolocation data of the user, and the social media activity of the user provided by the first network node and the second network node to at least one of the spending amount in the interaction, the time of purchase for the interaction, the item of purchase for the interaction, and the geolocation of the interaction to identify the anomaly.

19. The system of claim 15, wherein the processor comprises an artificial intelligence engine that compares the interaction data set to the first encrypted data set and the second encrypted data set to identify the anomaly, wherein the artificial intelligence engine is trained based on feature variables from the first encrypted data set and the second encrypted data set.

20. The system of claim 15, wherein the first encrypted data in the first network node is associated with a first user device type and the second encrypted data in the second network node is associated with a second user device type, wherein the first user device type and the second user device type are different.
